(19) United States
(12) Patent Application Publication
(10) Pub. No.: US 2015/0295331 A1
(43) Pub. Date: Oct. 15, 2015

(54) COAXIAL CABLE CONNECTOR WITH INTEGRAL RADIO FREQUENCY INTERFERENCE AND GROUNDING SHIELD

(71) Applicant: Corning Gilbert, Inc., Glendale, AZ (US)

(72) Inventor: Donald Andrew Burris, Peoria, AZ (US)

(73) Assignee: CORNING GILBERT INC., Glendale, AZ (US)

(21) Appl. No.: 14/750,435

(22) Filed: Jun. 25, 2015

Related U.S. Application Data
(63) Continuation of application No. 13/605,498, filed on Sep. 6, 2012.
(60) Provisional application No. 61/535,062, filed on Sep. 15, 2011.

(51) Int. Cl. H01R 9/05

(52) U.S. Cl. CPC H01R 9/05

(57) ABSTRACT

A coaxial cable connector for coupling a coaxial cable to an equipment port is disclosed. The coaxial cable connector comprises a tubular post, a coupler and a body. The coupler has a first end rotatably secured over the second end of the tubular post, and an opposing second end. The coupler includes a central bore extending therethrough. A portion of the central bore is proximate the second end of the coupler and adapted for engaging the equipment port. The body is secured to the tubular post and extends about a first end of the tubular post for receiving an outer conductor of the coaxial cable. A portion of at least one of the tubular post, the coupler and the body provides a spring-like force on the surface of at least one of the other of the tubular post, the coupler and the body to establish an electrically conductive path therebetween.

### RELATED APPLICATIONS

This application is a continuation of U.S. patent application Ser. No. 13/605,498 filed Sep. 6, 2012, which claims the benefit of priority under 35 U.S.C. §119 of U.S. Provisional Application Ser. No. 61/535,062 filed on Sep. 15, 2011. The content of both applications is relied upon and incorporated herein by reference in its entirety.

### BACKGROUND

1. Field of the Disclosure

The disclosure relates generally to coaxial cable connectors, and particularly to coaxial cable connectors having a flexible, resilient shield integral to one or more of the components which provides radio frequency interference (RFI) and grounding shielding independent of the tightness of the coaxial cable connector to an appliance equipment connection port, and without restricting the movement of the coupler of the coaxial cable connector when being attached to the appliance equipment connection.

2. Technical Background

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center conductor is surrounded by a dielectric material, and the dielectric material is surrounded by an outer conductor; this outer conductor may be in the form of a conductive foil and/or braided sheath. The outer conductor is typically maintained at ground potential to shield the signal transmitted by the center conductor from stray noise, and to maintain continuous desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector; this outer body of the connector is often fixedly secured to the tubular post. A coupler is typically rotatably secured around the tubular post and includes an internally-threaded region for engaging external threads formed on the outer conductor of the appliance terminal.

When connecting the end of a coaxial cable to a terminal of a television set, equipment box, or other appliance, it is important to achieve a reliable electrical connection between the outer conductor of the coaxial cable and the outer conductor of the appliance terminal. Typically, this goal is usually achieved by ensuring that the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post; in turn, the tubular post is engaged with the outer conductor of the coaxial cable.

With the increased use of self-install kits provided to home owners by some CATV system operators has come a rise in customer complaints due to poor picture quality in video systems and/or poor data performance in computer/internet systems. Additionally, CATV system operators have found upstream data problems induced by entrance of unwanted RF signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the homeowner. An improperly installed or loose connector may result in poor signal transfer because there are discontinuities along the electrical path between the devices, resulting in ingress of undesired radio frequency (“RF”) signals where RF energy from an external source or sources may enter the connector/cable arrangement causing a signal to noise ratio problem resulting in an unacceptable picture or data performance. Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be point of RF ingress as previously described.

As mentioned above, the coupler is rotatably secured about the head of the tubular post. The head of the tubular post usually includes an enlarged shoulder, and the coupler typically includes an inwardly-directed flange for extending over and around the shoulder of the tubular post. In order not to interfere with free rotation of the coupler, manufacturers of such F-style connectors routinely make the outer diameter of the shoulder (at the head of the tubular post) of smaller dimension than the inner diameter of the central bore of the coupler. Likewise, manufacturers routinely make the inner diameter of the inwardly-directed flange of the coupler of larger dimension than the outer diameter of the non-shoulder portion of the tubular post, again to avoid interference with rotation of the coupler relative to the tubular post. In a loose connection system, wherein the coupler of the coaxial connector is not drawn tightly to the appliance port connector, an alternate ground path may fortuitously result from contact between the coupler and the tubular post, particularly if the coupler is not centered over, and axially aligned with, the tubular post. However, this alternate ground path is not stable, and can be disrupted as a result of vibrations, movement of the appliance, movement of the cable, or the like.

Alternatively, there are some cases in which such an alternate ground path is provided by fortuitous contact between the coupler and the outer body of the coaxial connector, provided that the outer body is formed from conductive material. This alternate ground path is similarly unstable, and may be interrupted by relative movement between the appliance and the cable, or by vibrations. Moreover, this alternate ground path does not exist at all if the outer body of the coaxial connector is constructed of non-conductive material. Such unstable ground paths can give rise to intermittent failures that are costly and time-consuming to diagnose.

### SUMMARY OF THE DETAILED DESCRIPTION

One embodiment includes a coaxial cable connector for coupling a coaxial cable to an equipment port. The coaxial cable includes a center conductor surrounded by a dielectric material, the dielectric material being surrounded by an outer conductor. The coaxial cable connector comprises a tubular post a coupler and a body. The tubular post has a first end adapted to be inserted into the prepared end of the coaxial cable between the dielectric material and the outer conductor, and a second end opposite the first end thereof. The coupler has a first end rotatably secured over the second end of the tubular post, and an opposing second end. The coupler includes a central bore extending therethrough. A portion of the central bore is proximate the second end of the coupler and adapted for engaging the equipment port. The body is secured to the tubular post and extends about the first end of the tubular post for receiving the outer conductor of the coaxial cable. A portion of at least one of the tubular post, the coupler and the body member provides a spring-like force on the surface of at least one of the other of the tubular post, the coupler and the body member to establish an electrically conductive path therebetween. The portion maintains the electrically conductive path between the coaxial cable conductor and an equipment connection port of an appliance when the coupler is loosened from while in contact with the equipment connection port, and provides for unrestricted rotation of the coupler.

The portion may be integral to the at least one of the tubular post, the coupler and the body and may comprise at least one pre-formed cantilevered beam, or a plurality of pre-formed cantilevered annular beams. The pre-formed cantilevered annular beam may be arcuately shaped, and may comprise an outer surface with an edge. The edge may have a knife-like sharpness and provide a wiping action of surface oxides on the other of the tubular post, the coupler and the body. The at least one pre-formed cantilevered annular beam may be resilient relative to the longitudinal axis of the connector and maintain an arcuately increased surface of sliding electrical contact to the at least one of the other of the tubular post, the coupler and the body. Further, the portion may comprise a circular inner segment. The circular inner segment and the pre-formed annular beam may be metallic, and may be formed of phosphor bronze. The portion comprises a conductive material plating with the conductive material plating being one of tin and tin-nickel.

Another embodiment includes a coaxial cable connector for coupling a coaxial cable to an equipment port. The coaxial cable includes a center conductor surrounded by a dielectric material, the dielectric material being surrounded by an outer conductor. The coaxial cable connector comprises a tubular post a coupler and a body. The tubular post has a first end adapted to be inserted into the prepared end of the coaxial cable between the dielectric material and the outer conductor, and a second end opposite the first end thereof. The coupler has a first end rotatably secured over the second end of the tubular post, and an opposing second end. The coupler includes a central bore extending therethrough. A portion of the central bore is proximate the second end of the coupler and adapted for engaging the equipment port. The body is secured to the tubular post and extends about the first end of the tubular post for receiving the outer conductor of the coaxial cable.

A resilient, electrically-conductive integral shield element having an inner segment and at least one pre-formed cantilevered annular beam attached to the inner segment may be disposed proximate to and in contact with the body. The at least one pre-formed cantilevered annular beam exerts a spring-like force on the coupler, such that the integral shield element provides an electrically-conductive path between the body and the coupler. The integral shield element remains captured and secured and provides the electrically-conductive path independent of the tightness of the coaxial cable connector. The integral shield element may be generally circular and the at least one pre-formed cantilevered annular beam may be arcuately shaped. The second end of the tubular post may have an enlarged shoulder comprising a first rearward facing annular shoulder and a second rearward facing annular shoulder. The coupler may comprise a rearward facing annular surface, and the at least one pre-formed cantilevered annular beam exerts a spring-like force on the coupler at the rearward facing annular surface.

The integral shield element may be resilient relative to the longitudinal axis of the connector and maintains an arcuately increased surface of sliding electrical contact between the integral shield element and the rearward facing annular surface of the coupler. The at least one pre-formed cantilevered annular beam may comprise an outer surface with an edge, and wherein the edge has a knife-like sharpness and provides a wiping action of surface oxides on a surface of the coupler. The integral shield element provides for unrestricted rotation of the coupler and maintains the electrically conductive path between the coaxial cable conductor and an equipment connection port of an appliance when the coupler is loosened from while in contact with the equipment connection port and, therefore, provides the electrically-conductive path independent of the tightness of the coaxial cable connector.

The body and the post may be in intimate electrical and mechanical communication by means of a press-fit between corresponding conductive surfaces. The integral shield element provides an electrically conductive path between the body and the coupler providing a shield against RF ingress. The coaxial cable connector couples a prepared end of a coaxial cable to a threaded female equipment port. The tubular post has a first end adapted to be inserted into the prepared end of the coaxial cable between the dielectric material and the outer conductor thereof. The coupler is rotatably attached over a second end of the tubular post. The coaxial cable connector includes a central bore, at least a portion of which is threaded for engaging the female equipment port. The body extends about the first end of the tubular post for receiving the outer conductor, and preferably the cable jacket, of the coaxial cable.

A resilient, electrically-conductive integral shield element comprises a portion of one or more of the connector components and bridges between the said components. This integral shield element engages both the body and the coupler and, alternatively, the post for providing an electrically-conductive path therebetween, but without noticeably restricting rotation of the coupler relative to the tubular post. The integral shield element may be generally circular and includes a plurality of pre-formed flexible annular cantilevered beams. The tubular post comprises an enlarged shoulder extending inside the coupler with a first rearward facing annular shoulder and a stepped diameter leading to a second rearward facing annular shoulder. Alternatively, the post may comprise an integral shield element. As a further alternative, the post may be used in conjunction with a snap ring to retain the coupler. The coupler comprises a forward facing annular surface, a through-bore and a rearward facing annular surface. The body at least partially comprises an integral shield element, a face, a through bore and an external annular surface. In a preferred embodiment the integral shield element is proximate one end of the body and contacts the rearward facing annular surface of the coupler. The pre-formed flexible cantilevered annular beam(s) of the integral shield element are at least partially disposed against the rearward facing annular surface of the coupler. The integral shield element is resilient relative to the longitudinal axis of the connector and maintains an arcuately increased surface of sliding electrical contact between the integral shield element and the rearward facing annular surface of the coupler. At the same time the integral shield element is integral to the body providing electrical and mechanical communication between the coupler, and the body while allowing smooth and easy rotation of the coupler. The coaxial cable connector may also include a sealing ring seated within the coupler for rotatably engaging the body to form a seal therebetween.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross sectional view of an embodiment of a type of a coaxial connector comprising a body with an integral shield element as disclosed herein;

FIG. 1A is a detail section of a portion of FIG. 1;

FIG. 2 is a side cross sectional view of the body with the integral shield element;

FIG. 2A is a front schematic view of the body with the integral shield element;

FIG. 2B is a side schematic view of the body with the integral shield element;

FIGS. 3 through 3D inclusive are front schematic views of alternate embodiments of the body with the integral shield element;

FIG. 4 is a cross sectional view of an embodiment of a type of a coaxial connector comprising a coupler with an integral shield element as disclosed herein;

FIG. 4A is a detail section of a portion of FIG. 4;

FIG. 5 is a side cross sectional view of the coupler with the integral shield element;

FIG. 5A is a side schematic view of the coupler with the integral shield element;

FIG. 5B is a rear schematic view of the coupler with the integral shield element;

FIGS. 6 through 6D inclusive are rear schematic views of alternate embodiments of the coupler with the integral shield element;

FIG. 7 is a cross sectional view of the coaxial connector of FIG. 1 with a coaxial cable disposed therein.

FIG. 8 is a cross sectional view of an alternate embodiment of a type of a coaxial connector comprising a coupler with an integral shield element as disclosed herein;

FIG. 8A is a detail section of a portion of FIG. 8;

FIG. 9 is a cross sectional view of an alternate embodiment of a type of a coaxial connector comprising a coupler with an integral shield element as disclosed herein;

FIG. 9A is a detail section of a portion of FIG. 9;

FIG. 10 is a cross sectional view of an alternate embodiment of a type of a coaxial connector comprising a coupler with an integral shield element as disclosed herein;

FIG. 10A is a detail section of a portion of FIG. 10;

FIG. 11 is a cross sectional view of an alternate embodiment of a type of a coaxial connector comprising a post with an integral shield element as disclosed herein;

FIG. 11A is a detail section of a portion of FIG. 11;

FIG. 12 is a isometric schematic view of a post as related to FIG. 11 and FIG. 11A;

FIG. 13 is a cross sectional view of an alternate embodiment of a type of coaxial connector comprising a post with an integral shield element as disclosed herein;

FIG. 13A is a detail section of a portion of FIG. 13

### DETAILED DESCRIPTION OF THE DRAWINGS

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Coaxial cable connectors are used to couple a prepared end of a coaxial cable to a threaded female equipment connection port of an appliance. The coaxial cable connector may have a post or may be postless. In both cases though, in addition to providing an electrical and mechanical connection between the conductor of the coaxial connector and the conductor of the female equipment connection port, the coaxial cable connector provides a ground path from the braided sheath of the coaxial cable to the equipment connection port. Maintaining a stable ground path protects against the ingress of undesired radio frequency (“RF”) signals which may degrade performance of the appliance. This is especially applicable when the coaxial cable connector is loosened from the equipment connection port, either due to not being tightened upon initial installation or due to becoming loose after installation.

One embodiment includes a coaxial cable connector for coupling a coaxial cable to an equipment port. The coaxial cable includes a center conductor surrounded by a dielectric material, the dielectric material being surrounded by an outer conductor. The coaxial cable connector comprises a tubular post a coupler and a body. The tubular post has a first end adapted to be inserted into the prepared end of the coaxial cable between the dielectric material and the outer conductor, and a second end opposite the first end thereof. The coupler has a first end rotatably secured over the second end of the tubular post, and an opposing second end. The coupler includes a central bore extending therethrough. A portion of the central bore is proximate the second end of the coupler and adapted for engaging the equipment port. The body is secured to the tubular post and extends about the first end of the tubular post for receiving the outer conductor of the coaxial cable. A portion of at least one of the tubular post, the coupler and the body member provides a spring-like force on the surface of at least one of the other of the tubular post, the coupler and the body member to establish an electrically conductive path therebetween. The portion maintains the electrically conductive path between the coaxial cable conductor and an equipment connection port of an appliance when the coupler is loosened from while in contact with the equipment connection port, and provides for unrestricted rotation of the coupler.

The portion may be integral to the at least one of the tubular post, the coupler and the body and may comprise at least one pre-formed cantilevered beam, or a plurality of pre-formed cantilevered annular beams. The pre-formed cantilevered annular beam may be arcuately shaped, and may comprise an outer surface with an edge. The edge may have a knife-like sharpness and provide a wiping action of surface oxides on the other of the tubular post, the coupler and the body. The at least one pre-formed cantilevered annular beam may be resilient relative to the longitudinal axis of the connector and maintain an arcuately increased surface of sliding electrical contact to the at least one of the other of the tubular post, the coupler and the body. Further, the portion may comprise a circular inner segment. The circular inner segment and the pre-formed annular beam may be metallic, and may be formed of phosphor bronze. The portion comprises a conductive material plating with the conductive material plating being one of tin and tin-nickel.

Another embodiment includes a coaxial cable connector for coupling a coaxial cable to an equipment port. The coaxial cable includes a center conductor surrounded by a dielectric material, the dielectric material being surrounded by an outer conductor. The coaxial cable connector comprises a tubular post a coupler and a body. The tubular post has a first end adapted to be inserted into the prepared end of the coaxial cable between the dielectric material and the outer conductor, and a second end opposite the first end thereof. The coupler has a first end rotatably secured over the second end of the tubular post, and an opposing second end. The coupler includes a central bore extending therethrough. A portion of the central bore is proximate the second end of the coupler and adapted for engaging the equipment port. The body is secured to the tubular post and extends about the first end of the tubular post for receiving the outer conductor of the coaxial cable.

A resilient, electrically-conductive integral shield element having an inner segment and at least one pre-formed cantilevered annular beam attached to the inner segment may be disposed proximate to and in contact with the body. The at least one pre-formed cantilevered annular beam exerts a spring-like force on the coupler, such that the integral shield element provides an electrically-conductive path between the body and the coupler. The integral shield element remains captured and secured and provides the electrically-conductive path independent of the tightness of the coaxial cable connector. The integral shield element may be generally circular and the at least one pre-formed cantilevered annular beam may be arcuately shaped. The second end of the tubular post may have an enlarged shoulder comprising a first rearward facing annular shoulder and a second rearward facing annular shoulder. The coupler may comprise a rearward facing annular surface, and the at least one pre-formed cantilevered annular beam exerts a spring-like force on the coupler at the rearward facing annular surface.

The integral shield element may be resilient relative to the longitudinal axis of the connector and maintains an arcuately increased surface of sliding electrical contact between the integral shield element and the rearward facing annular surface of the coupler. The at least one pre-formed cantilevered annular beam may comprise an outer surface with an edge, and wherein the edge has a knife-like sharpness and provides a wiping action of surface oxides on a surface of the coupler. The integral shield element provides for unrestricted rotation of the coupler and maintains the electrically conductive path between the coaxial cable conductor and an equipment connection port of an appliance when the coupler is loosened from while in contact with the equipment connection port and, therefore, provides the electrically-conductive path independent of the tightness of the coaxial cable connector.

The body and the post may be in intimate electrical and mechanical communication by means of a press-fit between corresponding conductive surfaces. The integral shield element provides an electrically conductive path between the body and the coupler providing a shield against RF ingress. The coaxial cable connector couples a prepared end of a coaxial cable to a threaded female equipment port. The tubular post has a first end adapted to be inserted into the prepared end of the coaxial cable between the dielectric material and the outer conductor thereof. The coupler is rotatably attached over a second end of the tubular post. The coaxial cable connector includes a central bore, at least a portion of which is threaded for engaging the female equipment port. The body extends about the first end of the tubular post for receiving the outer conductor, and preferably the cable jacket, of the coaxial cable.

A resilient, electrically-conductive integral shield element comprises a portion of one or more of the connector components and bridges between the said components. This integral shield element engages both the body and the coupler and, alternatively, the post for providing an electrically-conductive path therebetween, but without noticeably restricting rotation of the coupler relative to the tubular post. The integral shield element may be generally circular and includes a plurality of pre-formed flexible annular cantilevered beams. The tubular post comprises an enlarged shoulder extending inside the coupler with a first rearward facing annular shoulder and a stepped diameter leading to a second rearward facing annular shoulder. Alternatively, the post may comprise an integral shield element. As a further alternative, the post may be used in conjunction with a snap ring to retain the coupler. The coupler comprises a forward facing annular surface, a through-bore and a rearward facing annular surface. The body at least partially comprises an integral shield element, a face, a through bore and an external annular surface. In a preferred embodiment the integral shield element is proximate one end of the body and contacts the rearward facing annular surface of the coupler. The pre-formed flexible cantilevered annular beam(s) of the integral shield element are at least partially disposed against the rearward facing annular surface of the coupler. The integral shield element is resilient relative to the longitudinal axis of the connector and maintains an arcuately increased surface of sliding electrical contact between the integral shield element and the rearward facing annular surface of the coupler. At the same time the integral shield element is integral to the body providing electrical and mechanical communication between the coupler, and the body while allowing smooth and easy rotation of the coupler. The coaxial cable connector may also include a sealing ring seated within the coupler for rotatably engaging the body to form a seal therebetween.

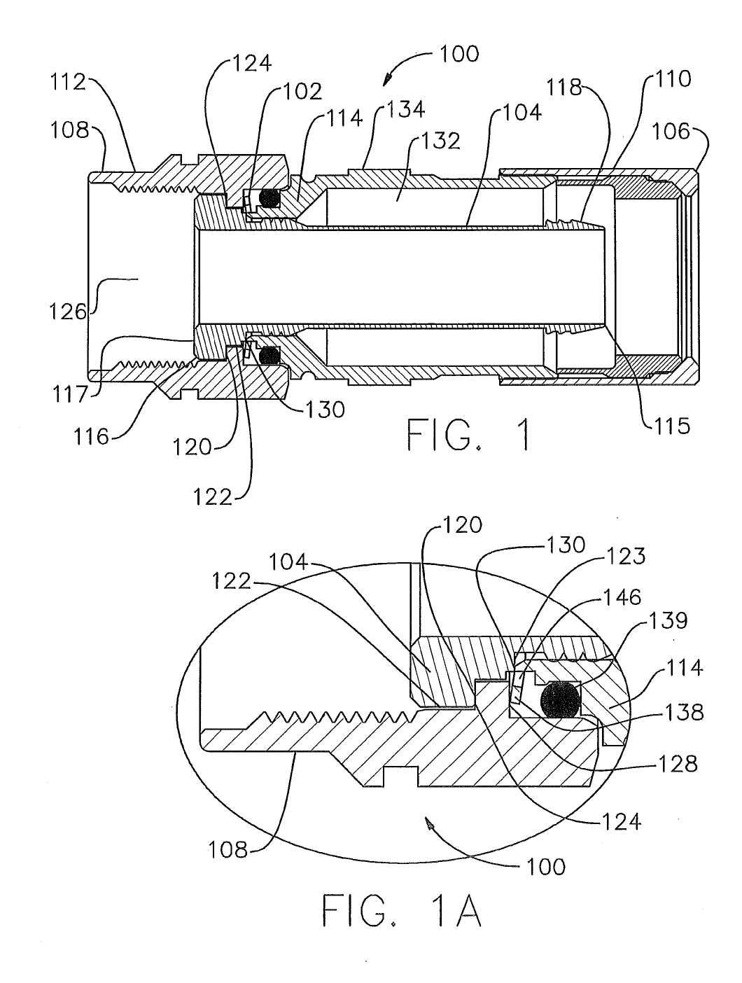

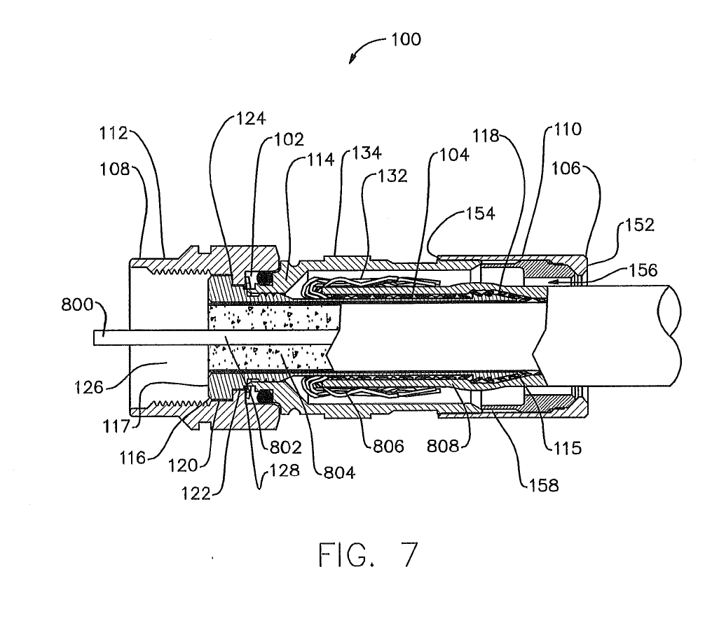

In this regard, FIGS. 1 and 1A illustrates an exemplary embodiment of coaxial cable connector 100 having body 114 comprising an integral shield element 102 to provide a stable ground path and protect against the ingress of RF signals. The coaxial cable connector 100 is shown in its unattached state, without a coaxial cable inserted therein. The coaxial cable connector 100 couples a prepared end of a coaxial cable to a threaded female equipment connection port (not shown in FIG. 1). This will be discussed in more detail with reference to FIG. 7. The coaxial cable connector 100 has a first end 106 and a second end 108. A shell 110 slidably attaches to the coaxial cable connector at the first end 106. A coupler 112 attaches to the coaxial cable connector 100 at the second end 108. The coupler 112 may rotatably attach to the second end 108, and, thereby, also to the tubular post 104. The integral shield element 102 is a unitized portion of the body 114 of the coaxial connector 100. In this way, the integral shield element 102 provides an electrically conductive path between the body 114, and the coupler 112. This enables an electrically conductive path from the coaxial cable through the coaxial cable connector 100 to the equipment connection port providing an electrical ground and a shield against RF ingress.

Continuing with reference to FIGS. 1 and 1A, the tubular post 104 has a first end 115 which is adapted to extend into a coaxial cable and a second end 117. An enlarged shoulder 116 at the second end 117 extends inside the coupler 112. At the first end 115, the tubular post 104 has a circular barb 118 extending radially outwardly from the tubular post 104. The enlarged shoulder 116 comprises a first rearward facing annular shoulder 120, and a stepped diameter 122 leading to a second rearward facing annular shoulder 123. The coupler 112 comprises a forward facing annular surface 124, a through-bore 126 and a rearward facing annular surface 128. The body 114 at least partially comprises an integral shield element 102, a face 130, a through bore 132 and an external annular surface 134. In this manner, the integral shield element 102 is secured within the coaxial cable connector 100, and establishes an electrically conductive path between the body 114 and the coupler 112. Further, the integral shield element 102 remains secured independent of the tightness of the coaxial cable connector 100 on the appliance equipment connection port. In other words, the integral shield element 102 remains secured and the electrically conductive path remains established between the body 114 and the coupler 112 even when the coaxial cable connector is loosened and/or disconnected from the appliance equipment connection port. Additionally, the integral shield element 102 has resilient and flexible cantilevered annular beams 138 disposed against the rearward facing annular surface 128 of the coupler 112. In this manner, the cantilevered annular beams 138 maintain contact with the coupler independent of tightness of the coaxial cable connector 100 on the appliance equipment connection port without restricting the movement, including the rotation of the coupler 112. The coaxial cable connector 100 may also include a sealing ring 139 seated within the coupler 112 to form a seal between the coupler 112 and the body 114.

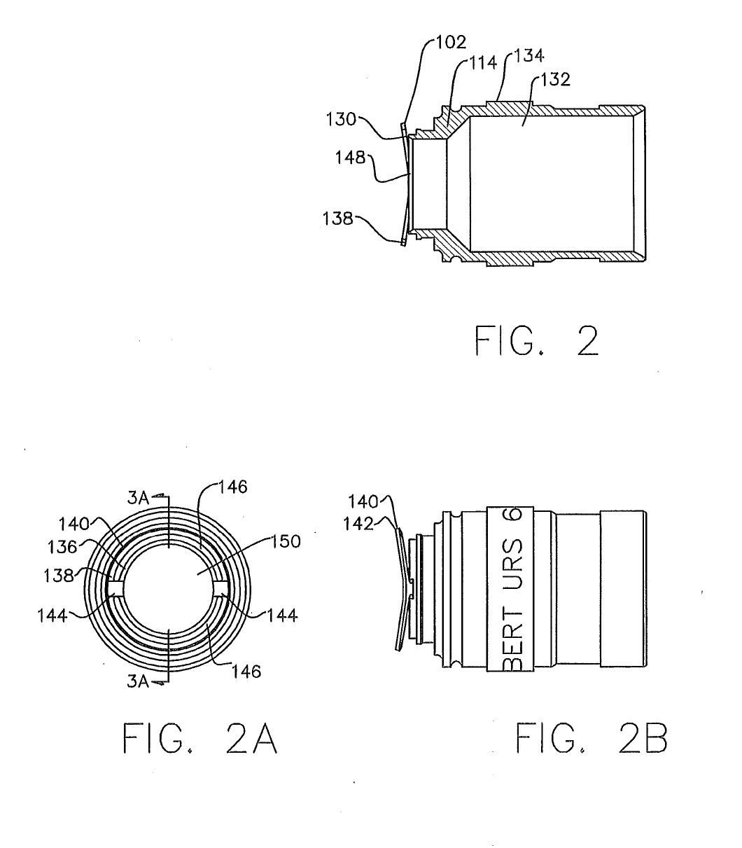

Referring now to FIGS. 2, 2A and 2B, the integral shield element 102 may be circular with the inner segment 136 and at least one pre-formed cantilevered annular beam 138. The least one pre-formed cantilevered annular beam 138 is flexible, arcuately shaped and extends at approximately a 19° angle from the plane of the inner segment 136. The pre-formed cantilevered annular beam 138 has an outer surface 140 with an edge 142, as shown in FIG. 2B. Joining segment 144 joins the pre-formed cantilevered annular beam 138 to the inner segment 136 forming a slot 146 therebetween. The inner segment 136 has an inner surface 148 that defines a central aperture 150. Body 114 and therefore integral shield element 102 may be made from a metallic material, including as a non-limiting examples, brass or phosphor bronze, additionally or alternatively, the integral shield element 102 may be un-plated or plated with a conductive material, as non-limiting examples tin, tin-nickel or the like.

Pre-forming the cantilevered annular beams 138 as illustrated in FIGS. 2 and 2B, provides the technical advantage of improved application of the material properties of the integral shield element 102 to provide a spring force biasing the edge 142 toward the rearward facing annular surface 128 and causing the edge 142 of outer surface 140 to intimately contact rearward facing annular surface 128 of the coupler 112. Because of this, the integral shield element 102 may be manufactured without having to utilize a more expensive material such as beryllium copper. Additionally, the material of the integral shield element 102 does not need to be heat treated. Further, the natural spring-like qualities of the selected material are utilized, with the modulus of elasticity preventing the integral shield element 102 from being over-stressed by providing for limited relative axial movement between coupler 112, the tubular post 104 and the body 114.

Electrical grounding properties are enhanced by providing an arcuately increased area of surface engagement between the edges 142 of the cantilevered annular beams 138 and rearward facing annular surface 128 of coupler 112 as compared, for example, to the amount of surface engagement of individual, limited number of contact points, such as raised bumps and the like. In this manner, the increased area of surface engagement provides the opportunity to engage a greater number of Asperity spots (“A-spots”) rather than relying on the limited number of mechanical and A-spot points of engagement. Additionally, the edge 142 may have a knife-like sharpness. Thus, the knife-like sharpness of the edge 142 makes mechanical contact between the cantilevered annular beams 138 and rearward facing annular surface 128 of coupler 112 without restricting the movement of the coupler 112. Also, the knife-like sharpness of the edge 142 and the plating of integral shield element 102 provide a wiping action of surface oxides to provide for conductivity during periods of relative motion between the components.

Moreover, in addition to the increased number of A-spot engagement, the increased area of surface engagement results in an increased area of concentrated, mechanical pressure. While providing the degree of surface contact and concentrated mechanical force, the integral shield element 102 does not negatively impact the “feel” of coupler rotation due to the limited amount of frictional drag exerted by the profile of edges 142 against reward facing annular surface 128.

The integral shield element 102 is resilient relative to the longitudinal axis of the coaxial cable connector 100 and maintains an arcuately increased surface of sliding electrical contact between integral shield element 102 and the rearward facing annular surface 128 of the coupler 112. At the same time the integral shield element 102, being part of the body 114, is firmly grounded through the body 114 providing assured electrical and mechanical communication between the coupler 112, and the body 114 while allowing smooth and easy rotation of the coupler 112.

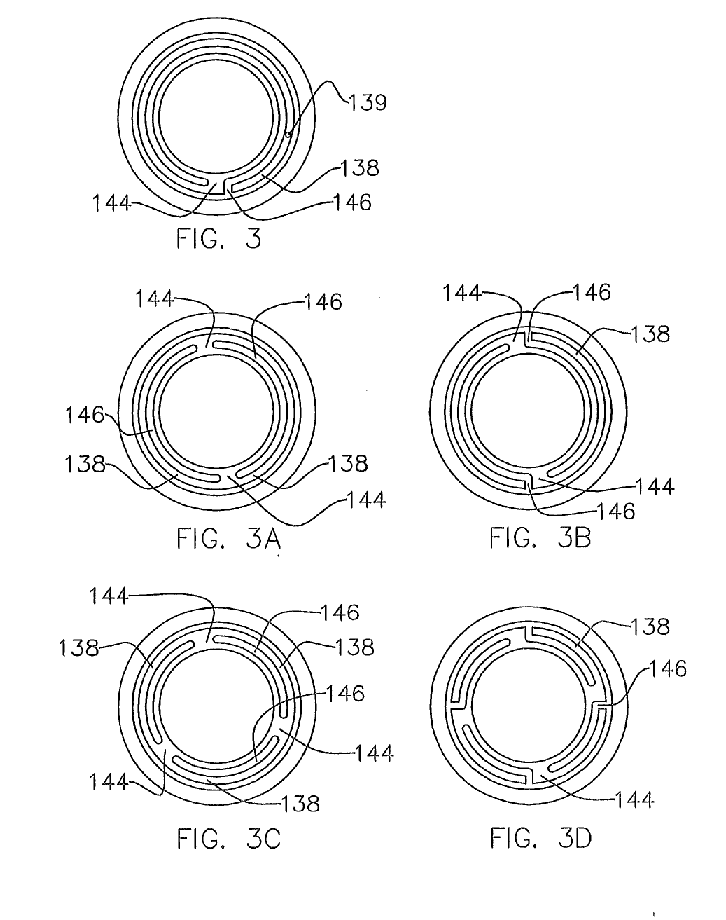

FIGS. 3 through 3D illustrate optional embodiments of the integral shield element 102 with differing patterns of slots 146, cantilevered annular beams 138, and the joining segments 144. Slots 146 may break through one side of the cantilevered beams 138 forming a single ended cantilevered beam or, alternatively, may not break out through one side of the cantilevered beam forming a double ended cantilevered beam. Endless variations and patterns may be achieved. Additionally and optionally, one or more of the beams may comprise one or more outwardly distended protuberances or bumps 139 as illustrated in FIG. 3

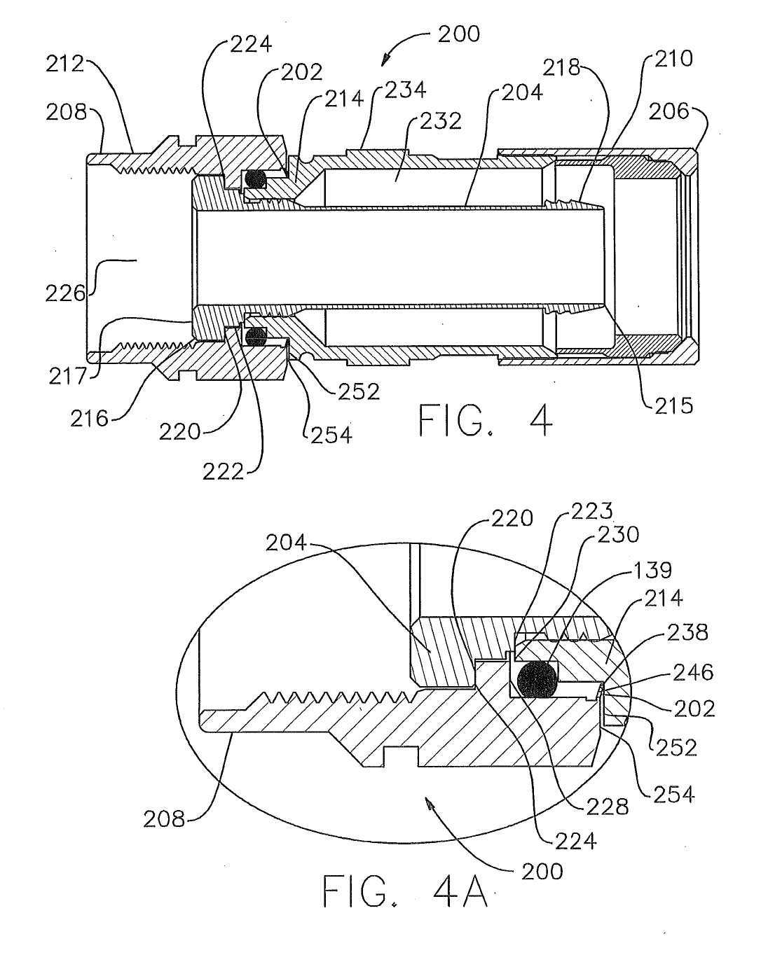

Referring now to FIGS. 4 and 4A, illustrate an exemplary embodiment of coaxial cable connector 200 having coupler 212 comprising an integral shield element 202 to provide a stable ground path and protect against the ingress of RF signals. The tubular post 204 has a first end 215 which is adapted to extend into a coaxial cable and a second end 217. An enlarged shoulder 216 at the second end 217 extends inside the coupler 212. At the first end 215, the tubular post 204 has a circular barb 218 extending radially outwardly from the tubular post 204. The enlarged shoulder 216 comprises a first rearward facing annular shoulder 220, a stepped diameter 222 leading to a second rearward facing annular shoulder 223. The coupler 212 comprises a forward facing annular surface 224, a through-bore 226, a rearward facing annular surface 228, an integral shield element 202 and a rear face 254. The body 214 at least partially comprises a face 230, a through bore 232 and an external annular surface 234 and a forward facing annular surface 252. Body 214 engages post 204 by means of a press fit between corresponding conductive surfaces. The integral shield element 202 of coupler 212 establishes an electrically conductive path between the coupler 212 and the forward facing annular surface 252 of body 214. Further, the integral shield element 202 remains in contact with forward facing annular surface 252 of body 214 independent of the tightness of the coaxial cable connector 200 on the appliance equipment connection port. In other words, the integral shield element 202 remains secured and the electrically conductive path remains established between the coupler 212 and the body 214 even when the coaxial cable connector is loosened and/or disconnected from the appliance equipment connection port. Additionally, the integral shield element 202 has resilient and flexible cantilevered annular beams 238 disposed against the forward facing annular surface 252 of the body 214. In this manner, the cantilevered annular beams 238 maintain contact with the post independent of tightness of the coaxial cable connector 200 on the appliance equipment connection port without restricting the movement, including the rotation of the coupler 212. The coaxial cable connector 200 may also include a sealing ring 139 seated within the coupler 212 to form a seal between the coupler 212 and the body 214.

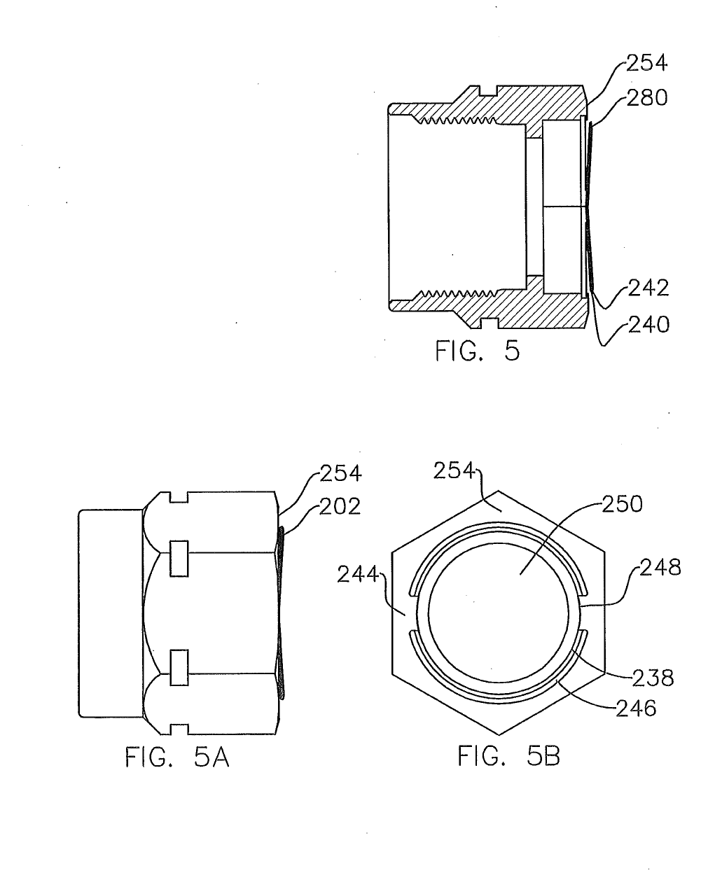

FIGS. 5 through 5A illustrate the coupler from connector 200 in FIGS. 4 and 4A wherein FIG. 5 is a side cross sectional view of the coupler with the integral shield element, FIG. 5A is a side schematic view of the coupler with the integral shield element and FIG. 5B is a rear schematic view of the coupler with the integral shield element. The integral shield element 202 of coupler 212 may be circular with the slot 246 and at least one pre-formed cantilevered annular beam 238. The least one pre-formed cantilevered annular beam 238 is flexible, arcuately shaped and extends at approximately a 19° angle from the plane of rear face 254. The pre-formed cantilevered annular beam 238 has an outer surface 240 with an edge 242, as shown in FIG. 2B. Joining segment 244 joins the pre-formed cantilevered annular beam 238 to the rear face 254 forming a slot 246 therebetween. Inner surface 248 defines a central aperture 250. Coupler 212 and therefore integral shield element 202 may be made from a metallic material, including as a non-limiting examples, brass or phosphor bronze, additionally or alternatively, the integral shield element 202 may be un-plated or plated with a conductive material, as non-limiting examples tin, tin-nickel or the like.

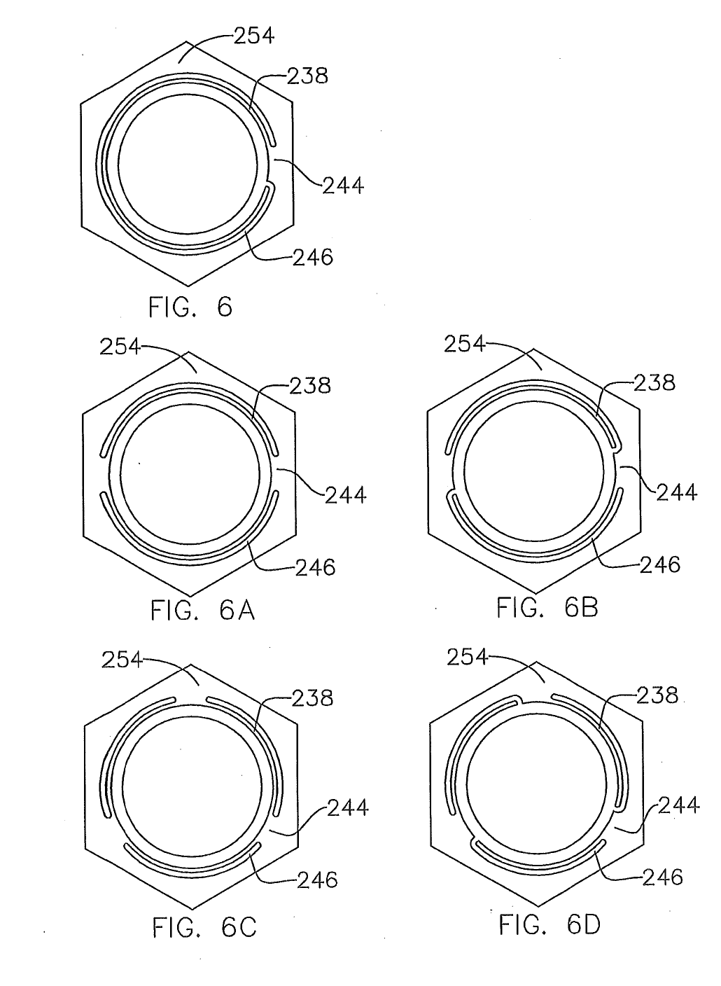

FIGS. 6 through 6D illustrate optional embodiments of the coupler 212 with integral shield element 202 with differing patterns of slots 246, cantilevered annular beams 238, and the joining segments 244. Slots 246 may break through one side of the cantilevered beams 238 forming a single ended cantilevered beam or, alternatively, may not break out through one side of the cantilevered beam forming a double ended cantilevered beam. Endless variations and patterns may be achieved.

Referring now to FIG. 7, the coaxial cable connector 100 is shown with a coaxial cable 800 inserted therein. The shell 106 has a first end 152 and an opposing second end 154. The shell 106 may be made of metal. A central passageway 156 extends through the shell 106 between first end 152 and the second end 154. The central passageway 156 has an inner wall 158 with a diameter commensurate with the outer diameter of the external annular surface 134 of the body 112 for allowing the second end 154 of the shell 106 to extend over the body 112. A gripping ring or member 160 (hereinafter referred to as “gripping member”) is disposed within the central passageway 156 of the shell 106. The central passageway 156 proximate the first end 152 of shell 106 has an inner diameter that is less than the diameter of the inner wall 158.

The coaxial cable 800 has center conductor 802. The center conductor 802 is surrounded by a dielectric material 804, and the dielectric material 804 is surrounded by an outer conductor 806 that may be in the form of a conductive foil and/or braided sheath. The outer conductor 806 is usually surrounded by a plastic cable jacket 808 that electrically insulates, and mechanically protects, the outer conductor. A prepared end of the coaxial cable 800 is inserted into the first end 106 of the coaxial cable connector 100. The coaxial cable 800 is fed into the coaxial cable connector 100 such that the circular barb 118 of the tubular post 104 inserts between the dielectric material 804 and the outer conductor 806 of the coaxial cable 800, making contact with the outer conductor 806. A compression tool (not shown) advances the shell 106 toward the coupler 112. As the shell 106 is advanced over the external annular surface 134 of the body 114 toward the coupler 112, the reduced diameter of the central passageway 156 forces the gripping member 160 against the cable jacket 808. In this manner, the coaxial cable 800 is retained in the coaxial cable connector 100. Additionally, the circular barb 118 positioned between the dielectric material 804 and the outer conductor 806 acts to maximize the retention strength of the cable jacket 802 within coaxial cable connector 100. As the shell 106 moves toward the second end of the coaxial cable connector 100, the shell 106 causes the gripper member 160 to compress the cable jacket 808 such that the cable jacket 808 is compressed between the gripper member 160 and the circular barb 118 increasing the pull-out force required to dislodge cable 800 from coaxial cable connector 100. Since the outer conductor 806 is in contact with the tubular post 104 an electrically conductive path is established from the outer conductor 206 through the tubular post 104 to the body 114 to the integral shield element 102 and, thereby, to the coupler 112.

Further, the integral shield element 102 being part of the body 114 within the connector 100 ensures the electrically-conductive path remains established independent of the tightness of the coaxial cable connector 100 on the appliance equipment connection port. In other words, the integral shield element 102 being part of the body 114 is inherently in the electrically conductive path established between the body 114 and coupler 112 even when the coaxial cable connector is loosened and/or disconnected from the appliance equipment connection port. Additionally, the integral shield element 102 has resilient and flexible cantilevered annular beams 138 disposed against the rearward facing annular surface 128 of the coupler 112. In this manner, the cantilevered annular beams 138 maintain contact with the coupler independent of tightness of the coaxial cable connector 100 on the appliance equipment connection port without restricting the movement, including the rotation of the coupler 112.

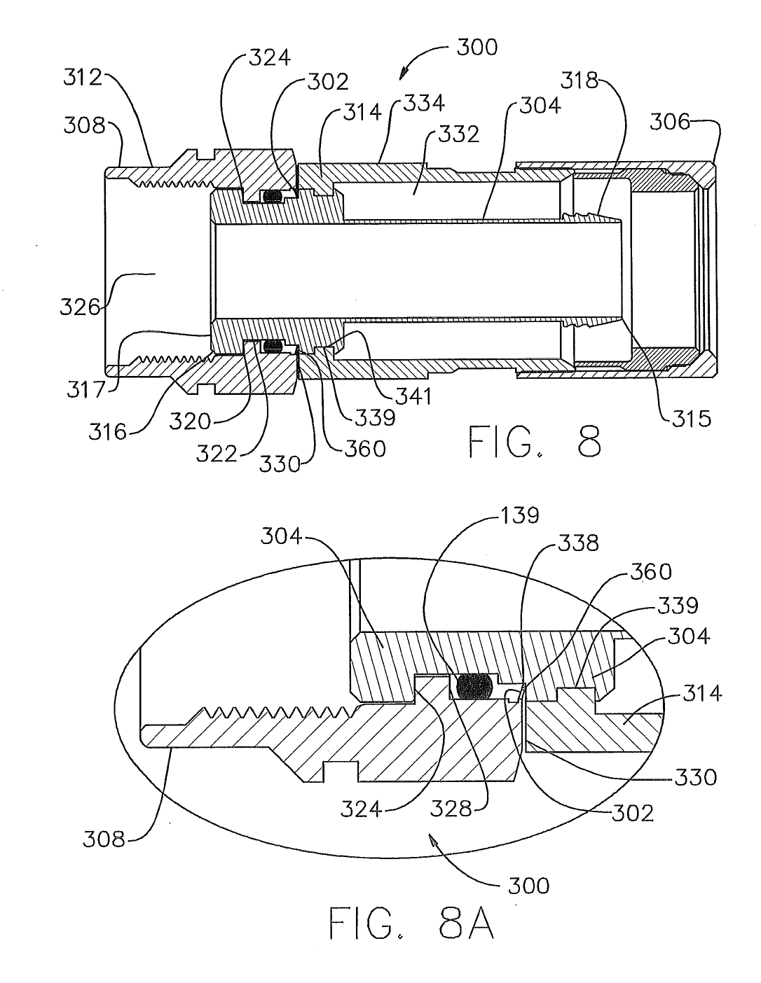

FIGS. 8 and 8A, illustrate an exemplary embodiment of coaxial cable connector 300 having coupler 312 comprising an integral shield element 302 to provide a stable ground path and protect against the ingress of RF signals. The tubular post 304 has a first end 315 which is adapted to extend into a coaxial cable and a second end 317. An enlarged shoulder 316 at the second end 317 extends inside the coupler 312. At the first end 315, the tubular post 304 has a circular barb 318 extending radially outwardly from the tubular post 304. The enlarged shoulder 316 comprises a first rearward facing annular shoulder 320, a stepped diameter leading to a second rearward facing annular shoulder 322 and a forward facing annular surface 360. Forward facing annular surface 360 may be orthogonal or oblique to the axis of body 314. The coupler 312 comprises a forward facing annular surface 324, a through-bore 326, a rearward facing annular surface 328, and an integral shield element 302. The body 314 at least partially comprises a face 330, a through bore 332, a reduced portion 339, and an external annular surface 334. In this embodiment the body 314 may be of a non-conductive material such as Acetal or the like. Body 314 may engage post 304 by means of a snap fit of reduced portion 339 of body 314 into annular groove 341 in post 304. The integral shield element 302 of coupler 312 establishes an electrically conductive path between the coupler 312 and the forward facing annular surface 360 of post 304. Further, the integral shield element 302 remains in contact with forward facing annular surface 360 of post 304 independent of the tightness of the coaxial cable connector 300 on the appliance equipment connection port. In other words, the integral shield element 302 remains secured and the electrically conductive path remains established between the coupler 312 and the post 304 even when the coaxial cable connector is loosened and/or disconnected from the appliance equipment connection port. Additionally, the integral shield element 302 has resilient and flexible cantilevered annular beams 338 disposed against the forward facing annular surface 360 of the post 304. In this manner, the cantilevered annular beams 338 maintain contact with the post independent of tightness of the coaxial cable connector 300 on the appliance equipment connection port without restricting the movement, including the rotation of the coupler 312. The coaxial cable connector 300 may also include a sealing ring 139 seated within the coupler 312 to form a seal between the coupler 312 and the post 304.

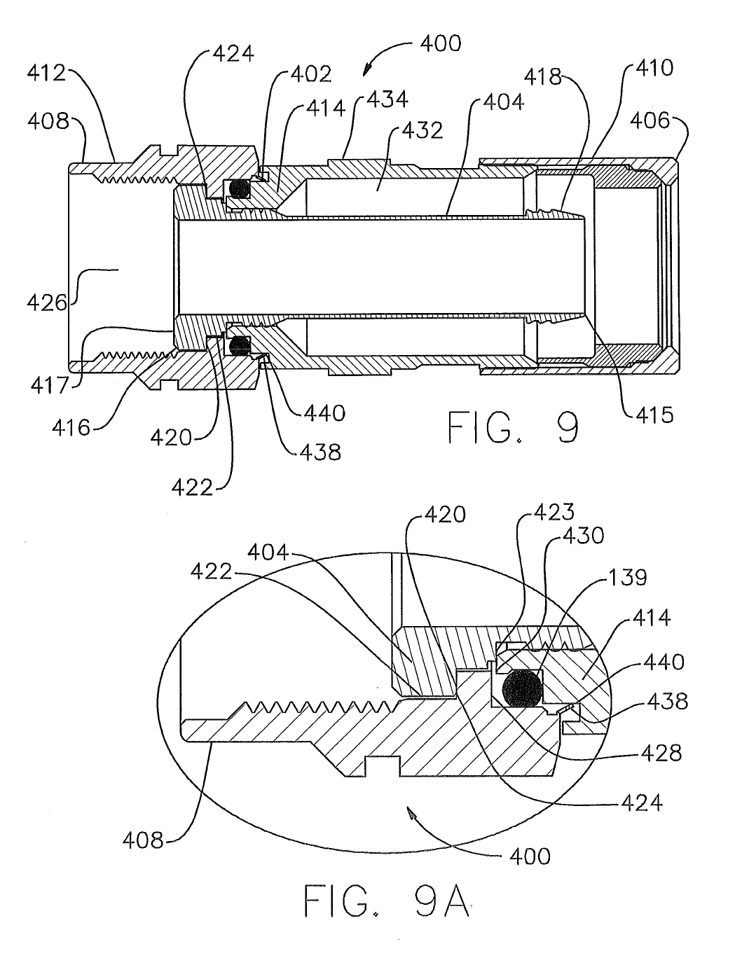

FIGS. 9 and 9A, illustrate an exemplary embodiment of coaxial cable connector 400 having coupler 412 comprising an integral shield element 402 to provide a stable ground path and protect against the ingress of RF signals. The tubular post 404 has a first end 415 which is adapted to extend into a coaxial cable and a second end 417. An enlarged shoulder 416 at the second end 417 extends inside the coupler 412. At the first end 415, the tubular post 404 has a circular barb 418 extending radially outwardly from the tubular post 404. The enlarged shoulder 416 comprises a first rearward facing annular shoulder 420, and a stepped diameter leading to a second rearward facing annular shoulder 422. The coupler 412 comprises a forward facing annular surface 424, a through-bore 426, a rearward facing annular surface 428, and an integral shield element 402. The body 414 at least partially comprises a face 430, a through bore 432 and an external annular surface 434 and an outer diameter 440. Outer diameter 440 may be orthogonal or oblique to the axis of body 414. Body 414 engages post 404 by means of a press fit between corresponding conductive surfaces. The integral shield element 402 of coupler 412 establishes an electrically conductive path between the coupler 412 and the outer diameter 440 of body 414. Further, the integral shield element 402 remains in contact with body 414 independent of the tightness of the coaxial cable connector 400 on the appliance equipment connection port. In other words, the integral shield element 402 remains secured and the electrically conductive path remains established between the body 404 and the coupler 412 even when the coaxial cable connector is loosened and/or disconnected from the appliance equipment connection port. Additionally, the integral shield element 402 has resilient and flexible cantilevered annular beams 438 disposed against the outer diameter 440 of body 414. In this manner, the cantilevered annular beams 438 maintain contact with the body independent of tightness of the coaxial cable connector 400 on the appliance equipment connection port without restricting the movement, including the rotation of the coupler 412. The coaxial cable connector 400 may also include a sealing ring 139 seated within the coupler 412 to form a seal between the coupler 412 and the body 414.

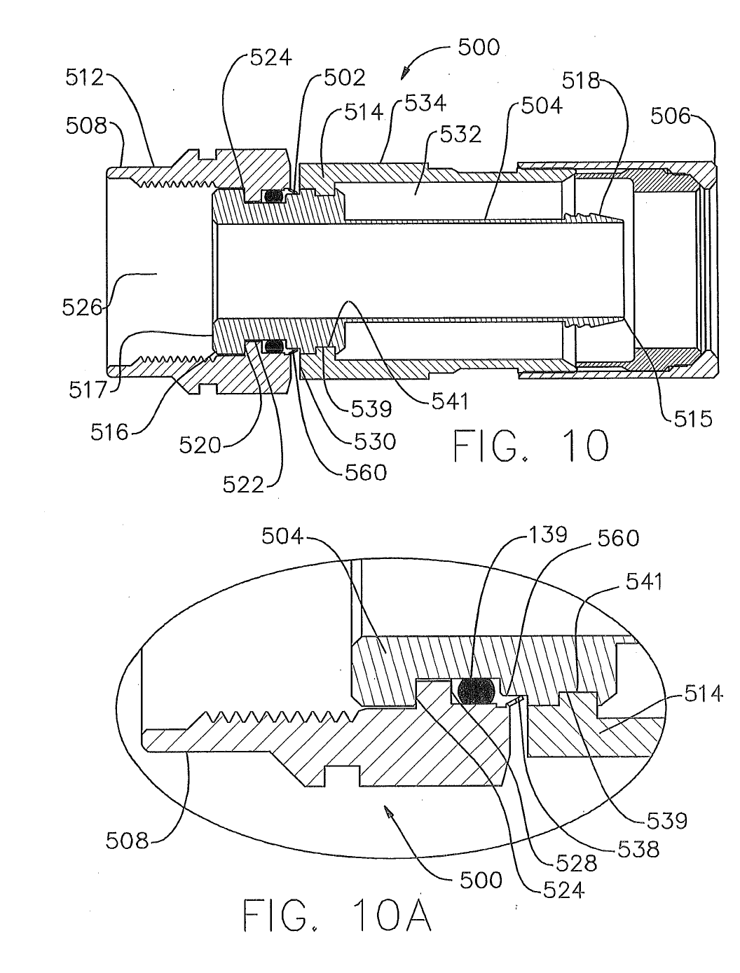

FIGS. 10 and 10A, illustrate an exemplary embodiment of coaxial cable connector 500 having coupler 512 comprising an integral shield element 502 to provide a stable ground path and protect against the ingress of RF signals. The tubular post 504 has a first end 515 which is adapted to extend into a coaxial cable and a second end 517. An enlarged shoulder 516 at the second end 517 extends inside the coupler 512. At the first end 515, the tubular post 504 has a circular barb 518 extending radially outwardly from the tubular post 504. The enlarged shoulder 516 comprises, at least partially, a first rearward facing annular shoulder 520, a stepped diameter leading to a second rearward facing annular shoulder 522 and an outer diameter 560. Outer diameter 560 may be orthogonal or oblique to the axis of body 514. The coupler 512 comprises a forward facing annular surface 524, a through-bore 526, a rearward facing annular surface 528, and an integral shield element 502. The body 514 at least partially comprises a face 530, a through bore 532, a reduced portion 539, and an external annular surface 534. In this embodiment the body 514 may be of a non-conductive material such as Acetal or the like. Body 514 may engage post 504 by means of a snap fit of reduced portion 539 of body 514 into annular groove 541 in post 504. The integral shield element 502 of coupler 512 establishes an electrically conductive path between the coupler 512 and the outer diameter 560 of post 504. Further, the integral shield element 502 remains in contact with outer diameter 560 of post 504 independent of the tightness of the coaxial cable connector 500 on the appliance equipment connection port. In other words, the integral shield element 502 remains secured and the electrically conductive path remains established between the post 504 and the coupler 512 even when the coaxial cable connector is loosened and/or disconnected from the appliance equipment connection port. Additionally, the integral shield element 502 has resilient and flexible cantilevered annular beams 538 disposed against the outer diameter 560 of post 504. In this manner, the cantilevered annular beams 538 maintain contact with the post independent of tightness of the coaxial cable connector 500 on the appliance equipment connection port without restricting the movement, including the rotation of the coupler 512. The coaxial cable connector 500 may also include a sealing ring 139 seated within the coupler 512 to form a seal between the coupler 512 and the post 504.

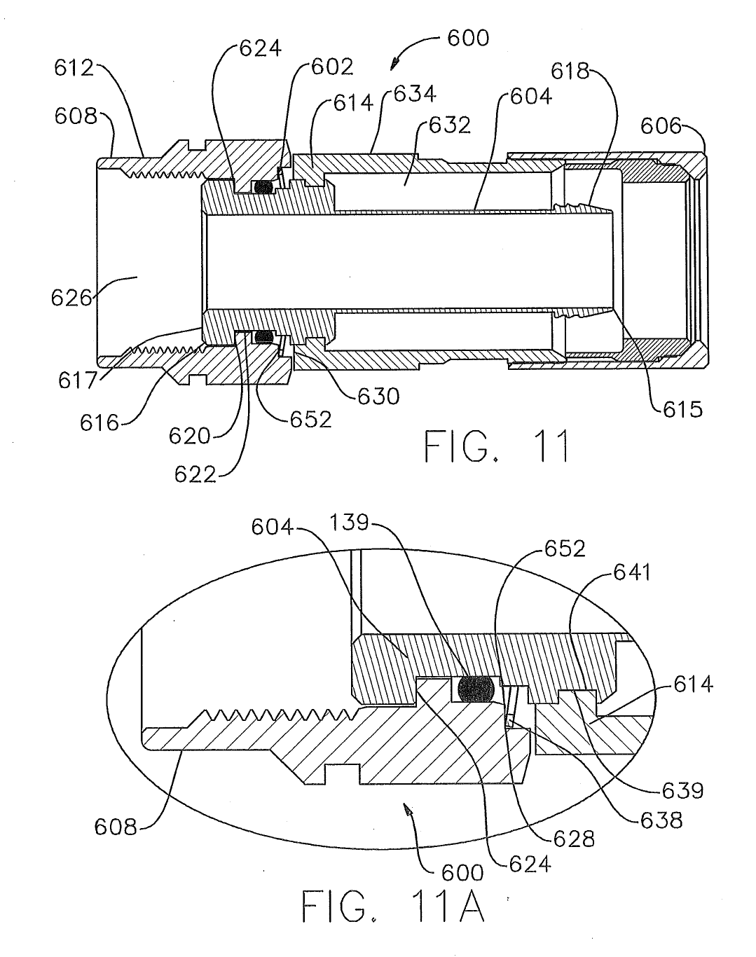

FIGS. 11 and 11A, illustrate an exemplary embodiment of coaxial cable connector 600 having coupler 612 comprising a forward facing annular surface 624, a through-bore 626, a rearward facing annular surface 628, and a rearward facing annular surface 652. Rearward facing annular surface 652 may be orthogonal or oblique to the axis of the coupler 612. The tubular post 604 has a first end 615 which is adapted to extend into a coaxial cable and a second end 617. An enlarged shoulder 616 at the second end 617 extends inside the coupler 612. At the first end 615, the tubular post 604 has a circular barb 618 extending radially outwardly from the tubular post 604. The enlarged shoulder 616 comprises a first rearward facing annular shoulder 620, a stepped diameter leading to a second rearward facing annular shoulder 622 and an integral shield element 602 to provide a stable ground path and protect against the ingress of RF signals. The body 614 at least partially comprises a face 630, a through bore 632, a reduced portion 639, and an external annular surface 634. In this embodiment the body 614 may be of a non-conductive material such as Acetal or the like. Body 614 may engage post 604 by means of a snap fit of reduced portion 639 of body 614 into annular groove 641 in post 604. The integral shield element 602 of post 604 establishes an electrically conductive path between the post 604 and the rearward facing annular surface 652 of the coupler 612. Further, the integral shield element 602 remains in contact with rearward facing annular surface 652 of the coupler 612 independent of the tightness of the coaxial cable connector 600 on the appliance equipment connection port. In other words, the integral shield element 602 remains secured and the electrically conductive path remains established between the post 604 and the coupler 612 even when the coaxial cable connector is loosened and/or disconnected from the appliance equipment connection port. Additionally, the integral shield element 602 has resilient and flexible cantilevered annular beams 638 disposed against the rearward facing annular surface 652 of the coupler 612. In this manner, the cantilevered annular beams 638 maintain contact with the coupler independent of tightness of the coaxial cable connector 600 on the appliance equipment connection port without restricting the movement, including the rotation of the coupler 612. The coaxial cable connector 600 may also include a sealing ring 139 seated within the coupler 612 to form a seal between the coupler 612 and the post 604.

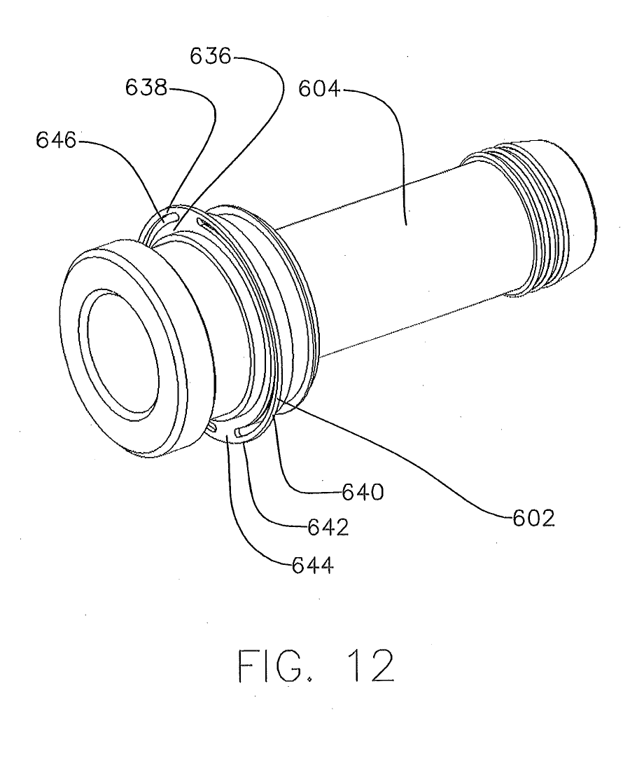

FIG. 12 is an isometric schematic view of a post 604 as related to FIG. 11 and FIG. 11A illustrating slots 646 and cantilevered annular beams 638 and other features as outlined herein. The integral shield element 602 may be circular with the inner segment 636 and at least one pre-formed cantilevered annular beam 638. The least one pre-formed cantilevered annular beam 638 is flexible, arcuately shaped and extends at approximately a 19° angle from the plane of the inner segment 636. The pre-formed cantilevered annular beam 638 has an outer surface 640 with an edge 642, as shown in FIG. 12. Joining segment 644 joins the pre-formed cantilevered annular beam 638 to the inner segment 636 forming a slot 646 therebetween. Post 604 and therefore integral shield element 602 may be made from a metallic material, including as a non-limiting examples, brass or phosphor bronze, additionally or alternatively, the integral shield element 602 may be un-plated or plated with a conductive material, as non-limiting examples tin, tin-nickel or the like.

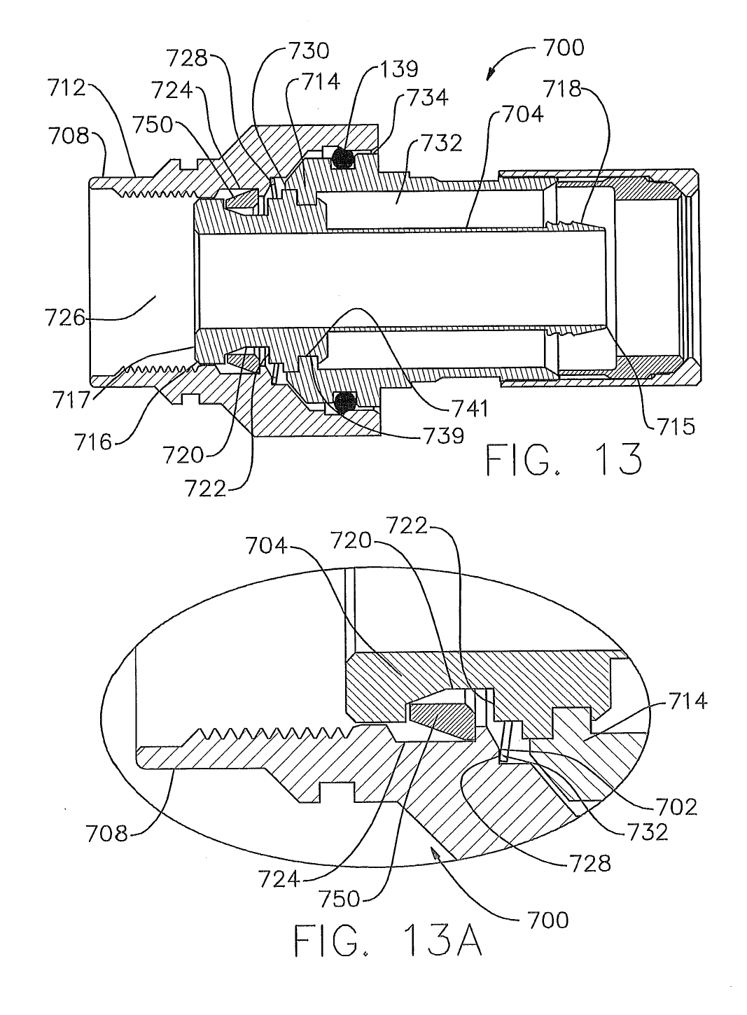

FIGS. 13 and 13A, illustrate an exemplary embodiment of coaxial cable connector 700 having coupler 712 at least partially comprising an annular recess 724, a through-bore 726, and a rearward facing annular surface 728. Communication Ring 750 is disposed between coupler 712 and post 704 allowing rotational coupling of the components while simultaneously providing mechanical and electrical communication between the components. Rearward facing annular surface 728 may be orthogonal or oblique to the axis of the coupler 712. The tubular post 704 has a first end 715 which is adapted to extend into a coaxial cable and a second end 717. An enlarged shoulder 716 at the second end 717 extends inside the coupler 712. At the first end 715, the tubular post 704 has a circular barb 718 extending radially outwardly from the tubular post 704. The enlarged shoulder 716 comprises a groove 720, leading to a forward facing annular shoulder 722 and an additional (additional to ring 750) and integral shield element 702 to provide another stable ground path and protect against the ingress of RF signals. The body 714 at least partially comprises a face 730, a through bore 732, a reduced portion 739, and an external annular surface 734. In this embodiment the body 714 may be of a non-conductive material such as Acetal or the like. Body 714 may engage post 704 by means of a snap fit of reduced portion 739 of body 714 into annular groove 741 in post 704. The integral shield element 702 of post 704 establishes an electrically conductive path between the post 704 and the rearward facing annular surface 728 of the coupler 712. Further, the integral shield element 702 remains in contact with rearward facing annular surface 728 of the coupler 712 independent of the tightness of the coaxial cable connector 700 on the appliance equipment connection port. In other words, the integral shield element 702 remains secured and the electrically conductive path remains established between the post 704 and the coupler 712 even when the coaxial cable connector is loosened and/or disconnected from the appliance equipment connection port. Additionally, the integral shield element 702 has resilient and flexible cantilevered annular beams 732 disposed against the rearward facing annular surface 728 of the coupler 712. In this manner, the cantilevered annular beams 732 maintain contact with the coupler independent of tightness of the coaxial cable connector 700 on the appliance equipment connection port without restricting the movement, including the rotation of the coupler 712. The coaxial cable connector 700 may also include a sealing ring 139 seated within the coupler 712 to form a seal between the coupler 712 and the body 714.

It will be apparent to those skilled in the art that various modifications and variations can be made to the embodiments discussed above. Additionally, the embodiments of the shield 102 may be used with other types of coaxial cable connector shield including without limitation, compression, compression-less and post-less coaxial cable connectors. Thus, it is intended that this description cover the modifications and variations of the embodiments and their applications.

What is claimed is:

1. A coaxial cable connector for coupling a coaxial cable to an equipment port, the coaxial cable including a center conductor surrounded by a dielectric material, the dielectric material being surrounded by an outer conductor, the coaxial cable connector comprising:
a tubular post having a first end adapted to be inserted into a prepared end of the coaxial cable between the dielectric material and the outer conductor, and having a second end opposite the first end thereof;
a coupler having a first end rotatably secured over the second end of the tubular post, and having an opposing second end, the coupler including a central bore extending therethrough, a portion of the central bore proximate the second end of the coupler being adapted for engaging the equipment port; and
a body secured to the tubular post and extending about the first end of the tubular post for receiving the outer conductor of the coaxial cable,
wherein a portion of at least one of the tubular post, the coupler and the body is integral to the portion of the at least one of the tubular post, the coupler and the body and provides a spring-like force on a surface of at least one of the other of the tubular post, the coupler and the body to establish an electrically conductive path therebetween.

2. The coaxial cable connector of claim 1, wherein the portion of the at least one of the tubular post, the coupler and the body is a unitized portion of the at least one of the tubular post, the coupler and the body.

3. The coaxial cable connector of claim 1, wherein the portion of the at least one of the tubular post, the coupler and the body comprises at least one pre-formed cantilevered beam.

4. The coaxial cable connector of claim 3, wherein the at least one pre-formed cantilevered annular beam is arcuately shaped.

5. The coaxial cable connector of claim 3, wherein the at least one pre-formed cantilevered annular beam comprises an outer surface with an edge, and wherein the edge has a knife-like sharpness and provides a wiping action of surface oxides on the at least one of the other of the tubular post, the coupler and the body.

6. The coaxial cable connector of claim 3, wherein the portion comprises a circular inner segment.

7. The coaxial cable connector of claim 6, wherein at least one of the circular inner segment and the at least one pre-formed cantilevered annular beam are metallic.

8. The coaxial cable connector of claim 6, wherein at least one of the circular inner segment and the at least one pre-formed cantilevered annular beam are formed of phosphor bronze.

9. The coaxial cable connector of claim 1, wherein the portion comprises a conductive material plating.

10. The coaxial cable connector of claim 9, wherein the conductive material plating is one of tin and tin-nickel.

11. The coaxial cable connector of claim 3, wherein the at least one pre-formed cantilevered annular beam comprises a plurality of pre-formed cantilevered annular beams.

12. The coaxial cable connector for claim 1 wherein the portion of the at least one of the tubular post, the coupler and the body provides the electrically-conductive path independent of the tightness of the coaxial cable connector.

13. The coaxial cable connector of claim 5, wherein the at least one pre-formed cantilevered annular beam is resilient relative to the longitudinal axis of the connector and maintains an arcuately increased surface of sliding electrical contact to the at least one of the other of the tubular post, the coupler and the body.

14. The coaxial cable connector of claim 1, wherein the portion of the at least one of the tubular post, the coupler and the body provides for unrestricted rotation of the coupler.

15. The coaxial cable connector of claim 1, wherein the portion of the at least one of the tubular post, the coupler and the body maintains the electrically conductive path between the coaxial cable conductor and an equipment connection port of an appliance when the coupler is loosened from while in contact with the equipment connection port.

16. A coaxial cable connector for coupling a coaxial cable to an equipment port, the coaxial cable including a center conductor surrounded by a dielectric material, the dielectric material being surrounded by an outer conductor, the coaxial cable connector comprising:
a tubular post having a first end adapted to be inserted into the prepared end of the coaxial cable between the dielectric material and the outer conductor, and having a second end opposite the first end thereof;
a coupler having a first end rotatably secured over the second end of the tubular post, and having an opposing second end, the coupler including a central bore extending therethrough, a portion of the central bore proximate the second end of the coupler being adapted for engaging the equipment port;
a body secured to the tubular post and extending about the first end of the tubular post for receiving the outer conductor of the coaxial cable; and
a resilient, electrically-conductive integral shield element integral to the body, the integral shield element having an inner segment and at least one pre-formed cantilevered annular beam attached to the inner segment, wherein the inner segment is disposed proximate to and in contact with the body, and the at least one pre-formed cantilevered annular beam exerts a spring-like force on the coupler, and wherein the integral shield element provides an electrically-conductive path between the body and the coupler.

17. The coaxial cable connector of claim 16, wherein the integral shield element remains captured and secured and provides the electrically-conductive path independent of the tightness of the coaxial cable connector.

18. The coaxial cable connector of claim 16, wherein the integral shield element is generally circular and the at least one pre-formed cantilevered annular beam is arcuately shaped.

19. The coaxial cable connector of claim 16, wherein the second end of the tubular post has an enlarged shoulder comprising a first rearward facing annular shoulder and a second rearward facing annular shoulder.

20. The coaxial cable connector of claim 16, wherein the coupler comprises a rearward facing annular surface, and wherein the at least one pre-formed cantilevered annular beam exerts a spring-like force on the coupler at the rearward facing annular surface.

21. The coaxial cable connector of claim 18, wherein the integral shield element is resilient relative to the longitudinal axis of the connector and maintains an arcuately increased surface of sliding electrical contact between the integral shield element and the rearward facing annular surface of the coupler.

22. The coaxial cable connector of claim 16, wherein the at least one pre-formed cantilevered annular beam comprises an outer surface with an edge, and wherein the edge has a knife-like sharpness and provides a wiping action of surface oxides on a surface of the coupler.

23. The coaxial cable connector of claim 16, wherein the integral shield element provides for unrestricted rotation of the coupler.

24. The coaxial cable connector of claim 16, wherein the integral shield element maintains the electrically conductive path between the coaxial cable conductor and an equipment connection port of an appliance when the coupler is loosened from while in contact with the equipment connection port.

25. The coaxial cable connector of claim 16 wherein the integral shield element is a unitized portion of the body.
